(19) United States
(12) Patent Application Publication
(10) Pub. No.: US 2023/0067298 A1
(43) Pub. Date: Mar. 2, 2023

(54) SENSOR SYSTEM FOR GRAIN STORAGE DEVICES

(71) Applicant: Sukup Manufacturing Co., Sheffield, IA (US)

(72) Inventors: Matthew Koch, Clear Lake, IA (US); Daniel Wayne Shrock, Raymondville, MO (US)

(21) Appl. No.: 17/895,376

(22) Filed: Aug. 25, 2022

Related U.S. Application Data
(60) Provisional application No. 63/237,565, filed on Aug. 27, 2021.

(51) Int. Cl. G01K 1/14; G01K 3/00; G01K 1/08; G01K 1/02; E04H 7/22; A01F 25/16

(52) U.S. Cl. CPC G01K 1/14; G01K 3/005; G01K 1/08; G01K 1/026; E04H 7/22; A01F 25/16

(57) ABSTRACT

A sensor system for a grain storage device is presented. The sensor system includes sensor cable segments configured to connected together in series to form a modular multi-segment sensor cable. In one or more arrangements, each sensor cable segment has a housing, a sensor circuit positioned in the housing, a support cable, and a data cable. The sensor circuit has an upper electrical connector and a lower electrical connector. The data cable is configured to communicatively connect the electrical connector of the segment with and the lower electrical connector of another segment. The support cable is configured to operably connect an upper end of the housing in one segment with a lower end of the housing of another segment in the sensors. The support cables and housings in the multi-segment sensor cable prevent strain on data cables and sensor circuits.

### CROSS-REFERENCE TO RELATED APPLICATIONS

The present application claims priority to U.S. Provisional Application 63/237,565, titled SENSOR SYSTEM FOR GRAIN STORAGE DEVICES, and filed on Aug. 27, 2021, the entirety of which is hereby incorporated by reference herein, including any figures, tables, drawings, or other information.

### FIELD OF THE DISCLOSURE

This disclosure relates to grain storage devices used in agriculture. More specifically and without limitation, this disclosure relates to a sensor system for grain storage devices such as grain bins.

### OVERVIEW

Grain storage devices are massive structures used to store bulk flowable grain products such as corn, soybeans, wheat, rice, nuts, pistachios, or any other grain or agricultural products or other material. One common form of grain storage devices is what are known as grain bins.

For simplicity purposes, reference is made herein to grain bins as one of countless examples of grain storage devices. However, the disclosure is not intended to be limited to grain bins and instead the disclosure is intended to apply to all grain storage devices. As such, unless specifically stated otherwise, reference to a grain bin is intended to include all forms of grain storage devices.

Similarly, for simplicity purposes, reference is made herein to grain. However, the disclosure is not intended to be limited to grain. Instead the disclosure is intended to apply to corn, soybeans, wheat, rice, nuts, popcorn, pistachios, small grains, large grains, unprocessed grains, processed grains, foodstuffs, unprocessed foodstuffs, processed foodstuffs, other commodities, or any other grain or agricultural products or other flowable material. As such, unless specifically stated otherwise, reference to grain is intended to include all forms of corn, soybeans, wheat, rice, nuts, popcorn, pistachios, small grains, large grains, unprocessed grains, processed grains, foodstuffs, unprocessed foodstuffs, processed foodstuffs, other commodities, or any other grain or agricultural products or other material.

Conventional grain bins are generally formed in a cylindrical shape with a corrugated sidewall covered by a peaked roof formed by a plurality of roof panels. Grain bins vary in height (ranging from twenty feet high to over a hundred and fifty feet high), and diameter (ranging from eighteen feet in diameter to over a hundred and fifty feet in diameter). The storage capacity of modern grain bins can range anywhere from a few thousand bushels to well over a million bushels.

Grain bins are often used to store grain for long periods of time. To ensure the stability of bulk grain during long-term storage the temperature and/or moisture level of the grain is closely monitored and controlled. More grain is damaged by improper storage conditions than any other reason. The most common problems are: inadequate observation of grain during storage (e.g., not checking grain frequently, improper grain management (e.g., not using aeration to control grain temperature), pockets of fines (broken kernels, weed seeds, and debris) that may restrict airflow and/or provide food for insects and mold, grain deteriorating because it was held too long without adequate aeration prior to drying, improper cooling of grain after drying, poor initial grain quality or insufficient drying to safe moisture content, freezing of grain, and/or improper or lack of insect control. To ensure the stability of bulk grain during long-term storage, environmental conditions within a grain bin must be monitored and controlled.

To facilitate monitoring, sensor systems may be installed in grain bins. Some sensor systems position a plurality of sensors along the lengths of cables with are hung from a roof and/or rafters of the grain bin. These are often custom made for specific lengths based on the height of a particular grain bin. However, it is common to expand capacity of a grain bin from time to time by detaching and lifting the roof and adding one or more rings to increase height of the grain bin. Unfortunately, after expanding capacity sensor cables cannot be easily expanded to facilitate monitoring the entire grain bin.

Therefore, for all the reasons stated above, and the reasons stated below, there is a need in the art for an improved sensor system for grain storage devices.

Thus, it is a primary object of the disclosure to provide a sensor system for grain storage devices that improves upon the state of the art.

Another object of the disclosure is to provide a sensor system that monitors environmental conditions throughout a grain storage device.

Yet another object of the disclosure is to provide a sensor system that permits real-time monitoring of environmental conditions throughout a grain storage device.

Another object of the disclosure is to provide a sensor system having modular sensor cables that can be increased and decreased in length.

Yet another object of the disclosure is to provide a sensor system that permits sensors to be replaced in the field without uninstalling sensor cables.

Another object of the disclosure is to provide a sensor system that is durable.

Yet another object of the disclosure is to provide a sensor system that is easy to manufacture.

Another object of the disclosure is to provide a sensor system that is relatively inexpensive.

Yet another object of the disclosure is to provide a sensor system that has a robust design.

Another object of the disclosure is to provide a sensor system that is high quality.

Yet another object of the disclosure is to provide a sensor system that is easy to install.

Another object of the disclosure is to provide a sensor system that can be installed using conventional equipment and tools.

Yet another object of the disclosure is to provide a sensor system that reduces grain bin corrosion.

Another object of the disclosure is to provide a sensor system that reduces grain spoilage.

Yet another object of the disclosure is to provide a sensor system that can be used with any grain bin.

These and other objects, features, or advantages of the disclosure will become apparent from the specification, figures, and claims.

### SUMMARY OF THE DISCLOSURE

In one or more arrangements, a sensor system for a grain storage device is provided. In one or more arrangements, the sensor system includes sensor cable segments that are configured to connected together in series to form a modular multi-segment sensor cable. In one or more arrangements, each sensor cable segment has a housing, a sensor circuit, a support cable, and a data cable. The housing has an elongated shape extending from an upper end to a lower end. The sensor circuit is positioned in the housing and has one or more sensors. The sensor circuit has an upper electrical connector and a lower electrical connector. The support cable extends from an upper end to a lower end. The support cable is configured to operably connect to the housing. The upper end of the support cable is configured to operably connect to the lower end of the housing and/or support cable of a higher one of the plurality of sensor cable segments in the multi-segment sensor cable. The data cable extends from an upper end to a lower end. The lower end of the data cable is configured to communicatively connect to the upper electrical connector of the sensor circuit. The upper end of the data cable is configured to communicatively connect to the lower electrical connector of the sensor circuit of the higher one or the plurality of sensor cable segments. During operation, the sensor circuit in each sensor cable segment is configured to communicate a data gathered from the one or more sensors of the sensor circuit via the data cable. Wherein, when a lower one of the plurality sensor cable segments in the multi-segment sensor cable is communicatively connected to the lower electrical connector of the sensor circuit, the sensor circuit is also configured to receive a data from the lower sensor cable segment and communicate the data via the data cable.

### BRIEF DESCRIPTION OF THE DRAWINGS

FIG. 1 shows an upper cutaway perspective view of an example grain bin having a sensor system, in accordance with one or more arrangements.

FIG. 2. shows an upper, front, left of a sensor cable segment for use in a modular multi-segment sensor cable, in accordance with one or more arrangements.

FIG. 3. shows a left side view of a sensor cable segment for use in a modular multi-segment sensor cable, in accordance with one or more arrangements.

FIG. 4 shows an exploded left side view of a sensor cable segment for use in a modular multi-segment sensor cable, in accordance with one or more arrangements.

FIG. 5. shows a left side view of two sensor cable segments connected in series to form a modular multi-segment sensor cable, in accordance with one or more arrangements.

FIG. 6 shows a partial lower front view of a sensor cable segment for use in a modular multi-segment sensor cable, in accordance with one or more arrangements.

FIG. 7. shows a front view of an example sensor circuit for use in a sensor cable segment of a modular multi-segment sensor cable, in accordance with one or more arrangements.

FIG. 8 shows a top cutaway view of a sensor cable segment proximate to the sensor circuit, in accordance with one or more arrangements.

FIG. 9. shows a side view of a sensor cable segment operably connected to a roof of a grain bin, in accordance with one or more arrangements; the view showing the sensor cable segment operably connected to a roof of a grain bin by a hanger bracket assembly.

FIG. 10. shows a front view of a sensor cable segment operably connected to a roof of a grain bin, in accordance with one or more arrangements; the view showing the sensor cable segment operably connected to a roof of a grain bin by a hanger bracket assembly.

FIG. 11. shows a side view of an example housing of a sensor cable segment, in accordance with one or more arrangements; the view showing a tie down positioned to be connected to a lower end of the housing.

FIG. 12. shows right side cross sectional view of a housing of a sensor cable segment, in accordance with one or more arrangements; the view showing the sensor cable segment having a support cable that extends the length of the sensor cable segment; the view showing the sensor cable segment having a data cable connected to an upper end of the housing.

FIG. 13. shows right side cross sectional view of a housing of a sensor cable segment, in accordance with one or more arrangements; the view showing the sensor cable segment having a support cable that extends the length of the sensor cable segment; the view showing the sensor cable segment having a data cable connected to a lower end of the housing.

FIG. 14. shows an upper, front, left of a sensor cable segment for use in a modular multi-segment sensor cable, in accordance with one or more arrangements; the view showing the sensor cable segment having a support cable that extends the length of the sensor cable segment and though the housing.

FIG. 15. shows a left side view of a sensor cable segment for use in a modular multi-segment sensor cable, in accordance with one or more arrangements; the view showing the sensor cable segment having a support cable that extends the length of the sensor cable segment and though the housing.

FIG. 16 shows an exploded left side view of a sensor cable segment for use in a modular multi-segment sensor cable, in accordance with one or more arrangements; the view showing the sensor cable segment having a support cable that extends the length of the sensor cable segment and though the housing.

FIG. 17. shows a left side view of two sensor cable segments connected in series to form a modular multi-segment sensor cable, in accordance with one or more arrangements; the view showing the sensor cable segment having a support cable that extends the length of the sensor cable segment and though the housing.

FIG. 18. shows an example control circuit for use in a sensor system for a grain bin, in accordance with one or more arrangements.

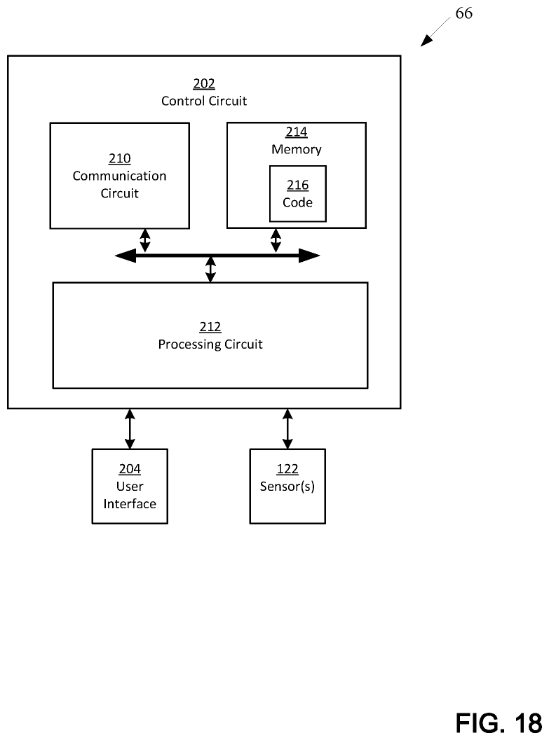

FIG. 19. shows an example sensor programmer for use with a sensor system for a grain bin, in accordance with one or more arrangements.

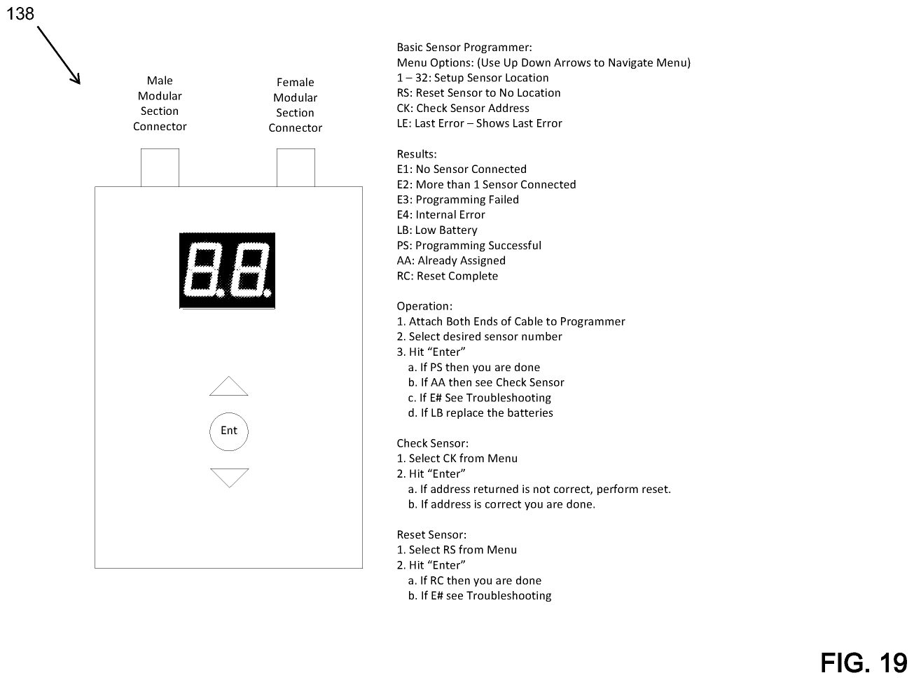

FIG. 20. shows a flowchart diagram of an example process for controlling operation of a grain bin in response to sensor data acquired by a sensor system, in accordance with one or more arrangements.

FIG. 21. shows a flowchart diagram of another example process for controlling operation of a grain bin in response to sensor data acquired by a sensor system, in accordance with one or more arrangements.

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in and/or described with reference to certain figures and/or embodiments, it will be appreciated that features from one figure and/or embodiment may be combined with features of another figure and/or embodiment even though the combination is not explicitly shown and/or explicitly described as a combination. In the depicted embodiments, like reference numbers refer to like elements throughout the various drawings.

It should be understood that any advantages and/or improvements discussed herein may not be provided by various disclosed embodiments, and/or implementations thereof. The contemplated embodiments are not so limited and should not be interpreted as being restricted to embodiments that provide such advantages and/or improvements. Similarly, it should be understood that various embodiments may not address all or any objects of the disclosure and/or objects of the invention that may be described herein. The contemplated embodiments are not so limited and should not be interpreted as being restricted to embodiments that address such objects of the disclosure and/or invention. Furthermore, although some disclosed embodiments may be described relative to specific materials, embodiments are not limited to the specific materials and/or apparatuses but only to their specific characteristics and capabilities and other materials and apparatuses can be substituted as is well understood by those skilled in the art in view of the present disclosure. Moreover, although some disclosed embodiments may be described in the context of window treatments, the embodiments are not so limited. In is appreciated that the embodiments may be adapted for use in other applications which may be improved by the disclosed structures, arrangements and/or methods.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation and/or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments and/or methods.

Similarly, the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually, and/or sequentially, to provide looping and/or other series of operations aside from single operations described below. It should be presumed that any embodiment and/or method having features and functionality described below, in any workable combination, falls within the scope of example embodiments.

As used herein, various disclosed embodiments may be primarily described in the context of grain bins. However, the embodiments are not so limited. It is appreciated that the embodiments may be adapted for use in other applications, which may be improved by the disclosed structures, arrangements and/or methods. The system is merely shown and described as being used in the context of grain bins for ease of description and as one of countless example applications.

Turning now to the figures, a modular sensor cable system 10 (or simply system 10) is presented for monitoring agricultural products in a grain bin 12, as is shown as one example.

### Grain Bin 12:

In the arrangement shown, as one example, sensor system 10 is used in association with a grain bin 12. However, it is hereby contemplated that sensor system 10 may be used with any grain storage device and use with grain bin 12 is only one of countless examples. As such, unless stated otherwise, reference to grain bin 12 is intended to imply any grain storage device.

Grain bin 12 may be formed of any suitable size, shape, and design and is configured to hold a bulk amount of flowable material such as grain or the like materials. In one or more arrangements, as is shown, grain bin 12 is a large, generally cylindrical structure that has a curved sidewall 14. Sidewall 14 connects at its lower end to a foundation 16. Sidewall 14 connects at its upper end to a peaked roof 18.

Sidewall 14 of grain bin 12 is formed of any suitable size, shape, and design and is configured to enclose sides of grain bin 12. In one or more arrangements, as is shown, sidewall 14 is formed of a plurality of sheets 20 of material. Sheets 20 have an upper edge 22, a lower edge 24, and side edges 26. Sheets 20 have in exterior surface 28 and interior surface 30 (not show). In the arrangement shown, as one example, these sheets 20 are formed of corrugated material. That is, when sheets 20 are viewed from their side edge 26, the sheets 20 have a repetitive oscillating curve that smoothly transitions between rounded peaks and rounded valleys, similar to that of a sine-wave or sine-function. This corrugation provides strength and rigidity to the sheets of material that form sidewall 14. Any other configuration of sidewall 14 and more broadly grain bin 12 or even more broadly a grain storage device, is hereby contemplated for use in association with sensor system 10.

Sheets 20 of sidewall 14 may be formed of a single layer of material. Alternatively, to increase the strength and rigidity of the sidewall 14 a plurality of sheets 20 may be laid over one another, thereby forming what is known as a “laminated” sheet 20 of sidewall 14. Laminated sheets 20 may include two, three, four, five, or any other number of layers.

In one or more arrangements, as is shown, sheets 20 curve slightly from side edge 26 to side edge 26 such that each sheet 20 forms a partial portion of a cylinder. In this example arrangement, a plurality of sheets 20 are connected together in side-to-side arrangement to form what is known as a ring 32. In one or more arrangements, as is shown, rings 32 are vertically stacked to form sidewall 14, which extends from foundation 16 at its lower end to peaked roof 18 at its upper end.

In the arrangement shown, as one example, grain bin 12 includes a roof 18. Roof 18 may be formed of any suitable size, shape, and design and is configured to cover and enclose the upper end of grain bin 12. In the arrangement shown, as one example, roof 18 is formed of a plurality of panels 34. In the arrangement shown, as one example, panels 34 extend a length from an upper end 36 to a lower end 38. In the arrangement shown, as one example, panels 34 extend a width between opposing ribs 40. Each panel 34 may be formed of a single piece of material or multiple pieces of material that are connected to one another.

In the arrangement shown, as one example, upper end 36 of panels 34 connect to or terminate at center ring 42. In the arrangement shown, as one example, center ring 42 is a generally circular shaped member that has a hollow interior that provides a passageway into the hollow interior of grain bin 12 that is used to fill grain bin 12 with grain. The assembly of center ring 48 also facilitates the connection of the upper end 36 of panels 34 to center ring 42, thereby securing the upper end 36 of panels 34. In the arrangement shown, as one example, center ring 42 is positioned at the approximate middle or center of grain bin 12. Any other configuration is hereby contemplated for center ring 42.

In the arrangement shown, as one example, upper end 36 of panels 34 is positioned above lower end 38 of panel 34 so as to facilitate water, dust, dirt, and debris that collects on roof 18 to shed downward and outward away from grain bin 12. In the arrangement shown, as one example, lower end 38 of panels 34 extend past sidewall 14 a distance so as to facilitate water, dust and debris that is shed off of roof 18 clears sidewall 14, thereby keeping sidewall 14 clean and dry.

In the arrangement shown, as on example, upper end 36 of panels 34 are narrower than lower end 38 of panels 34. This arrangement allows a plurality of panels 34 to extend around the center point of roof 18 while extending downward and outward from the center point. In the arrangement shown, as one example, ribs 40 of one panel 34 nest with the ribs 40 of the adjacent panels 34 in an overlapping and nesting condition. In the arrangement shown, as one example, to facilitate this overlapping and nesting condition, ribs 40 are formed of trapezoidal shaped members, or more specifically isosceles trapezoid shaped members, when viewed from the upper end 36 or lower end 38 of panel 34. However, any other shape is hereby contemplated for use as ribs 40.

In the arrangement shown, as one example, panel 34 is generally flat and planar between upper end 36 and lower end 38 and between the interior edges of opposing ribs 40. In the arrangement shown, as one example, ribs 40 add strength and rigidity to panel 34 and roof 18. In addition, ribs 40 provide a convenient, strong, secure and easy-to-install/assemble manner of connecting adjacent panels 34. In the arrangement shown, as one example, when ribs 40 of adjacent panels 34 are nested with one another in overlapping condition, fasteners, such as screws or bolts can be passed through the overlapping ribs 40, thereby securing adjacent panels to one another. In addition, fasteners such as screws or bolts can be passed through portions of roof 18 and into other portions of grain bin 12, thereby securing roof 18 to grain bin 12.

In the arrangement shown, roof 18 includes one or more roof vents 50 positions in panels 34 of roof. Roof vents 50 facilitate may be opened to facilitate movement of air through grain bin 12 or may be closed to seal in the content of grain bin 12.

### Sensor System 10:

Sensor system 10 is formed of any suitable size, shape, and design and is configured to facilitate positioning and gathering data from sensors distributed inside of a grain bin 12. In one or more arrangements, system 10 includes a plurality of modular sensor cable systems 60, hanger bracket assemblies 62, tie downs 64, and a data system 66 communicatively connected to the modular sensor cable systems 60, among other components.

### Modular Sensor Cable System(s) 60:

Modular sensor cable system 60 is formed of any suitable size, shape, and design and is configured to facilitate connecting a plurality of sensors 122 along an adjustable cable length. In the arrangement shown, modular sensor cable system 60 includes a plurality of sensor cable segments 70 that are configured to be connectable together in a daisy chain configuration and facilitate length adjustment of the modular sensor cable system 60 by adding or removing sensor cable segments 70 from the daisy chain. In the arrangement shown, as one example, modular sensor cable system 60 includes a respective sensor cable segment 70 for each ring 32 of grain bin 12 to facilitate monitoring of grain in each ring 32. However, the embodiments are not so limited. Rather, it is contemplated that in one or more arrangements modular sensor cable system 60 may include any number of sensor cable segments 70, which may have any length, and/or which may have more or fewer number of sensors 122.

### Sensor Cable Segments 70

Sensor cable segments 70 are formed of any suitable size, shape, and design and are configured to facilitate connecting the sensor cable segments 70 together in a daisy chain to facilitate positioning a plurality of sensors 122 along a length of modular sensor cable system 60 and communication of data from the plurality of sensors to data system 66. In the arrangement shown, as one example, each sensor cable segment 70 has a housing 74, a sensor circuit 76, a support cable 78, and a data cable 80, among other components.

### Housing 74:

Housing 74 is formed of any suitable size, shape, and design and is configured to house a sensor circuit 76, operably connect with support cable 78, facilitate connection of data cable 80 with sensor circuit 76, and facilitate the ability to operably connect support cable 78 of another sensor cable segment 70. In one or more arrangements shown, as one example, housing 74 has an elongated rectangular shape having a front 86, a back 88, and opposing sides 90 extending from an upper end 92 to a lower end 94. In this example arrangement, housing 74 has a recess 100 in the front 86 to receive and hold sensor circuit 76 therein. In this example arrangement, housing 74 has elongated channels 102 extending upward and downward from recess 100 to accommodate and facilitate connection of data cables 80 with sensor circuit 76.

In various arrangements, housing may be fabricated using various different methods and/or means including but not limited to, for example, milling/machining, cutting, casting, forging, stamping, welding, extruding, and/or any other means or method for fabrication. As one example, in one or more arrangements, housing may be formed by stamping a rectangular piece of sheet metal into a U or taco shape to form housing 74. Such stamp fabrication may help to reduce manufacturing time and costs while providing a strong housing configured to aid in support of the multi-segment modular sensor cable 70. However, the arrangement are not so limited. Rather, it is contemplated that in various arrangements, housing 74 may be formed of various materials including but not limited to, for example, metallic materials (e.g., aluminum, steel, iron, brass, copper, lead, tin, magnesium, zinc, pewter, titanium, or any other metallic material or alloy or the like), polymer plastics (e.g., acrylic, ABS, Nylon, PLA, Polybenzimidazole, polycarbonate, polyether sulfone, polyoxymethylene, polyetherimide, polyethylene, polyethylene oxide, polyethylene sulfide, polypropylene, polystyrene, polyamide, polypropylene, alkyd, silicon resins, polyvinyl chloride, polyvinylidene fluoride, Teflon, acrylic, epoxy, polyurethane, polyamide, polycarbonate, polypropylene, alkyd, and/or silicon resins), natural materials (e.g., wood and/or textiles) and/or composite materials.

Covers 104:

In one or more arrangements, housing 74 has covers 104. Covers 104 are formed of any suitable size, shape, and design and are configured to connect with housing 74 and cover sensor circuit 76 in recess 100 and data cables 80 in channels 102. In the arrangement shown, as one example, covers 104 are shaped to fit within recess 100 and/or channels 102.

In this example arrangement, covers 104 have connection features 108 around edges of the covers 104 that engage connection features 110 of the housing 74 to connect covers 104 with housing 74. In this example arrangements, connection features 108 of covers are protrusions that engage holes in housing 74 that form connection features 110. However, the embodiments are not so limited. Rather, it is contemplated that in some various different arrangements, covers 104 may connect with housing 74 using various means and methods known in the art including but not limited to, for example: eyes, links, loops, sockets, threads, screws, bolts, buttons, clips, clamps, grips, saddles, ferrules, tucks, interconnects, friction fittings, clips, pins, clamps, other coupling devices, welds, adhesives, chemical bonding, or the like or combinations thereof.

Upper Connection Feature 112 and Lower Connection Feature 114:

In this example arrangement, housing 74 has an upper connection feature 112 to facilitate connection of upper end 92 of housing 74 with a lower end 144 of support cable 78.

In this example arrangement, housing 74 also has a lower connection feature 114 to facilitate connecting lower end 94 of housing 74 with an upper end of a support cable 78 of another sensor cable segment 70 to facilitate connecting the segments together in daisy chain.

In the arrangement shown, upper connection feature 112 and lower connection feature 114 of housing 74 are threaded holes configured to receive and engage threaded termination connectors 146 of support cable 78 to operably connect housing with support cable(s) 78. However, the embodiments are not so limited. Rather, it is contemplated that in some various different arrangements, upper connection feature 112 and lower connection feature 114 of housing 74 may connect with termination connectors 146 of support cable 78 using various means and methods known in the art including but not limited to, for example: eyes, links, loops, sockets, threads, screws, bolts, buttons, clips, clamps, grips, saddles, ferrules, tucks, interconnects, friction fittings, clips, pins, clamps, other coupling devices, welds, adhesives, chemical bonding, or the like or combinations thereof.

When multiple sensor cable segments 70 of modular sensor cable 60 are connected together in a daisy chain and hung in a grain bin 12, the weight of sensor cable segments 70 is supported entirely by the connected support cables 78 and housings 74 of the modular sensor cable 60. This arrangement may help prevent weight of sensor cable segments 70 from applying stress upon the data cables 80 and sensor circuits 76, which could lead to damage. This arrangement also permits a damaged sensor circuit 76 in one of the sensor cable segments 70 to be removed for repair and/or replacement while keeping the sensor cable segments 70 connected together.

### Sensor Circuit 76:

Sensor circuit 76 is formed of any suitable size, shape, and design and is configured to acquire data from one or more sensors and communicate the acquired data, and data received from other sensor cable segments 70, via data cable 80. In one or more arrangements, as one example, sensor circuit includes a printed circuit board (PCB) 120, one or more sensors 122, a processing circuit 124, an upper electrical connector 126, and a lower electrical connector 128, among other components.

Printed Circuit Board 120:

PCB 120 is formed of any suitable size, shape, and design and is configured to interconnect and support sensors 122, processing circuit 124, upper electrical connector 126, and/or lower electrical connector 126 of sensor circuit 76. In the arrangement shown, as one example, PCB 120 has an elongated generally rectangular shape extending from an upper end 132 to a lower end 134. In this example arrangement, upper electrical connector 126 is operably connected to upper end 132 of PCB 120 and lower electrical connector 126 is operably connected to lower end 134 of PCB 120.

Sensors 122:

Sensors 122 are formed of any suitable size, shape, and design, and are configured to measure various environmental or other aspects that may affect storage, conditioning, and/or treatment of contents of grain bin 12. In some various arrangements, sensors 122 may include but are not limited to, for example, temperature sensors, humidity sensors, moisture sensors, chemical sensors, optical sensors, motion sensors, sound or vibration sensors, pressure sensors, RF sensors, and/or any other type of sensor. In some arrangements, sensors 122 may be formed along with processing circuit 124 as a single combined integrated circuit. Alternatively, in some arrangements, sensors 122 and processing circuit 124 may be separate components that are communicatively connected together.

Processing Circuit 124:

Processing circuit 124 is formed of any suitable size, shape, and design, and is configured to communicatively connect with sensor(s) 122 of sensor circuit 76, upper electrical connector 126, and lower electrical connector 126 and facilitate communication of sensor data along the chain of connected sensor cable segments 70. In the arrangement shown, as one example, processing circuit 124 is configured to communicate measurement data acquired from sensor(s) 122, and data received from other sensor cable segments via lower electrical connector 128, upward along modular sensor cable 60 via data cable 80 connected to upper electrical connector 126. However, the embodiments are not so limited. Rather, it is contemplated that in various different arrangements, processing circuits 124 of sensor cable segments 70 may be configured to communicate data upward along modular sensor cable 60, communicate data upward along modular sensor cable 60, and/or communicate data both upward and downward along modular sensor cable 60.

Although the arrangements are primarily described with reference to sensor cable segments 70 being connected in a daisy chain network topology, the embodiments are not so limited. Rather, it is contemplated that in some various different arrangements, sensor cable segments 70 and/or modular sensor cables 60 may be connected to communicate data in any type of network topology including but not limited to, for example, daisy-chain, data bus, ring, tree, mesh, star, hybrid, ad-hoc, and/or any other network topology.

Moreover, while the arrangements are primarily described with reference to wired communication, cable segments 70 over data cables 80 along modular sensor cable 60, the embodiments are not so limited. Rather, it is contemplated that in one or more arrangements, processing circuits 124 of sensor circuits 76 may be configured to communicate sensor data wirelessly. It is also contemplated that in some various different arrangements, processing circuits 124 of sensor circuits 76 may be configured to communicate data over data cables 80 along modular sensor cable 60 (or wirelessly) using various communication technologies and protocols over various networks and/or mediums including but not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LTE, FM/VHF/UHF networks, and/or any other communication protocol, technology or network. Likewise, it is also contemplated that in some various different arrangements, processing circuits 124 of sensor circuits 76 may be configured to communicate data over data cables 80 along modular sensor cable 60 (or wirelessly using various access control methods including but not limited to, for example, polling (e.g., by a designated master sensor cable segments 70), token passing, contention based access control (e.g., Carrier Sense Multiple Access with Collision Avoidance and Carrier Sense Multiple Access with Collision Detection), and/or any other method or means for controlling access to a transmission medium.

Processing circuit 124 may be any suitable circuit configured for implementing these operations/activities, as shown in the figures and/or described in the specification including but not limited to, for example, discreet logic circuits and/or programmable circuits. In certain arrangements, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of software code stored in and accessible from a memory. Such memory may be any form of information storage such as flash memory, ram memory, dram memory, a hard drive, or any other form of memory.

In one or more arrangements, processing circuit 124 of sensor circuit 76 is configured to communicate sensor data using a format, protocol, and/car method that permits the identity and/or position of the sensor circuit 76 containing the sensor 122 that generated the data to be determined. For instance; in some arrangements, data system 66 may determine identity and; or position of sensors to facilitate interpretation of the sensor data (e.g., creating a 3D map of sensor readings).

As one example, in one or more arrangements, sensor circuits 76 may be programmed to communicate data in assigned frequencies and/or time slots so as to permit data system 66 to determine which sensor circuit 76 generated the data.

As another example, in one or more arrangements, each sensor circuit 76 may be configured to append its data to the end of data received from the lower sensor cable segment 70. Data system 66 may then determine which sensor generated which data from the order of the sensor readings in the data.

As yet another example, in one or more arrangements, data from each sensor circuit 76 may be communicated in a respective packet having header information that can be used to identify which sensor circuit 76 generated the data. For instance, in some implementations, such header information may include a unique identifier (e.g., a MAC address or other identifier) assigned to the sensor circuit 76 when manufactured. When installing sensors circuits 76 and/or connecting sensor cable segments 70 to form a modular sensor cable 60, the unique identifier of each sensor circuit 76 may be recorded and input to data system 66 for later use to facilitate interpretation of the data.

As yet another example, in some implementations, sensor circuits 76 may be programmed to store information indicating the position of the corresponding sensor cable segment 70 in the modular sensor cable 60 when installing sensors circuits 76 and/or connecting sensor cable segments 70 to form a modular sensor cable 60. Additionally or alternatively, in some implementations, sensor circuits 76 may be programmed to store information to indicate which modular sensor cable 60 the sensor circuit 76 is located. The programmed information of each sensor circuit 76 may be recorded and input to data system 66 for later use to facilitate interpretation of the data.

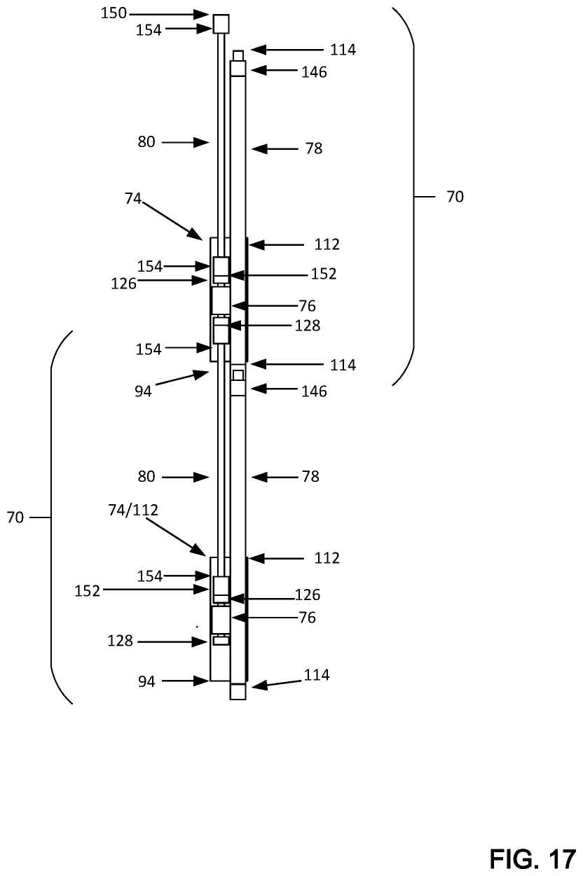

As an illustrative example, FIG. 17 shows an example sensor programmer 138 that may be used to program sensor circuits 76 in accordance with one or more arrangements. In this illustrative example, the sensor programmer 138 is configured to be connected to end(s) of modular sensor cable 60 to facilitate assignment of identifiers and/or further configuration of sensor circuits 76 after identifiers are assigned. In this example arrangement, sensor programmer 138 is configured to assign a position identifier to a single unassigned sensor circuit 76 present on the modular sensor cable 60 at time.

As an example process, data cables 80 at ends of modular sensor cable 60 are connected to programmer. Then starting at a first sensor cable segment 70 at one end of modular sensor cable 60:
1) Install sensor circuit 76 in the housing 74 of the sensor cable segment 70.
2) Connect electrical connectors 154 of adjacent data cables 80 to electrical connectors 126/128 of the sensor circuit 76.
3) Enter desired sensor number to indicate the position of the sensor circuit 76 and hit enter.
4) if display reads PS, programming was successful. Move to next sensor cable segment 70 and do back to steps 1-4 until sensor circuits 76 for all sensor cable segment 70 are programed.

However, the embodiments are not limited to these illustrative examples. Rather, it is contemplated that in some various arrangements, sensor circuit 76 may utilize any format, protocol, and/or method that permits the identity and/or position of the sensor circuit 76 containing the sensor 122 that generated the data to be determined.

### Support Cable 78:

Support cable 78 is formed of any suitable size, shape, and design and is configured to operably connect with and suspend housing 74, and any sensor cable segments 70 suspended from housing 74, from a structure that is operably connected to an upper end 142 of support cable 78. In the arrangement shown, as one example, support cable 78 is a flexible steel cable type support structure extending from an upper end 142 to a lower end 144 with termination connectors 146 attached to the upper end 142 and the lower end 144. However, the embodiments are not so limited. Rather, it is contemplated that in some various different arrangements, support cable 78 may be implemented using various different support structures including but not limited to, for example, cables, cords, chains, ropes, wires, straps, belts, rods, bars, and/or any other method or means for suspending objects.

Termination Connectors 146:

Termination connectors 146 are formed of any suitable size, shape, and design and are configured to facilitate connection of lower end 144 of support cable with upper connection feature 112 and facilitate connection with lower connection feature 114 of another sensor cable segment 70 and/or hanger bracket assemblies 62. In the arrangement shown, as one example, termination connectors 146 are threaded posts. However, the embodiments are not so limited. Rather, it is contemplated that in some various different arrangements, termination connectors 146 may be implemented using various different types of connectors including but not limited to, for example: eyes, links, loops, sockets, threads, screws, bolts, buttons, clips, clamps, grips, saddles, ferrules, tucks, interconnects, friction fittings, clips, pins, clamps, other coupling devices, welds, adhesives, chemical bonding, or the like or combinations thereof

### Data Cable 80:

Data cable 80 is formed of any suitable size, shape, and design and is configured to facilitate transmission of data along the modular sensor cable 60. In the arrangement shown, as one example, data cable 80 is a flexible data cable extending from an upper end 150 to a lower end 152 with electrical connectors 154 attached to the upper end 150 and the lower end 152 of the data cable 80. In various different arrangements, data cable 80 may be implemented using various different types of shielded and/or unshielded data cables including but not limited to, for example, twisted pair (e.g., CAT1/CAT2/CAT3/CAT4/CAT5/CAT6/CAT7), ribbon cables, parallel wire, ladder line, coax, fiber optic, serial cables, USB cable, firewire cable, and/or any other type of cable for data transmission.

Electrical Connectors 126, 128, and 154:

Electrical connectors 126 and 128 of sensor circuit 76 and electrical connectors 154 of data cable 80 are formed of any suitable size, shape, or design, and are configured to electrically connect data cables 80 of with sensor circuits 76 in the modular sensor cable 60. In the arrangement shown, as one example, electrical connectors 126 and 128 of sensor circuit 76 are electrically connected to sensor circuit 76 by short cable segments 130. In this example arrangement, the short cable segments 130 may make it easier to connect electrical connectors 126 and 128 of sensor circuit 76 with electrical connectors 154 of data cable 80 when deployed in the field. However, the embodiments are not so limited. Rather, it is contemplated that in one or more embodiments, electrical connectors 126 and 128 of sensor circuit 76 may be mounted one PCB 120, housing 74, and/or other component(s) of sensor cable segment 70.

In various different arrangements, electrical connectors 126, 128, and 154 may be implemented using various different types of cable connectors including but not limited to, for example, DIN style connectors, Mini DIN style connectors, DB style connectors, 0.050 style connectors, VHDCI style connectors, Centronics style connectors, Mini Centronics style connectors, RJ style connectors, BNC style connectors, USB style connectors, FIREWIRE style connectors, Thunderbolt style connectors, DVI style connectors, mini DVI style connectors, HDMI DVI style connectors, fiber optic style connectors, coaxial style connectors, token ring style connectors, banana plug style connectors, spade style connectors, ring style connectors, XLR style connectors, other audio and/or video style connectors, power cord style connectors, and/or any other type of connector.

### Hanger Bracket Assemblies 62:

Hanger bracket assemblies 62 are formed of any suitable size, shape, and design and are configured to operably connect upper end 142 of support cable 78 of a top sensor cable segment 70 of modular sensor cable 60 to an elevated structure of grain bin 12. In some arrangements, as is shown, hanger bracket assemblies 62 are configured to facilitate adjustment to the height at which the support cabled is attached to hanger bracket assemblies 62. Such height adjustment may be useful, for example, when hanger bracket assemblies 62 are connected to the interior of a self supporting roof 18 of grain bin 12 (e.g., ribs 40 of a panel 34 of roof 18), in order to position a set of modular sensor cables all the same height. In the arrangement shown, hanger bracket assemblies 62 include a bracket 160, a vertical member 162, and a fastener 164, among other components.

### Bracket 160:

Bracket 160 is formed of any suitable size, shape, and design and is configured to operably connect vertical member 162 to an elevated mounting point of grain bin 12. In the arrangement shown, as one example, bracket 160 has an elongated generally rectangular shape extending between opposing ends 168, where bracket connects with ribs 40 of a panel 34 of roof 18. In some various different arrangements, bracket 160 may be connected to mounting point(s) of grain bin 12 using various means and methods known in the art including but not limited to, for example: eyes, links, loops, sockets, threads, screws, bolts, buttons, clips, clamps, grips, saddles, ferrules, tucks, interconnects, friction fittings, clips, pins, clamps, other coupling devices, welds, adhesives, chemical bonding, or the like or combinations thereof. Alternatively, in some arrangements, vertical member 162 may be connected directly to grain bin 12 and bracket 160 omitted.

### Vertical Member 162:

Vertical member 162 is formed of any suitable size, shape, and design and is configured to provide a plurality of positions at a plurality of different heights at which a top sensor cable segment 70 of modular sensor cable 60 may be connected. In the arrangement shown, as one example, vertical member 162 has an elongated generally rectangular shape extending downward from an upper end 172, where vertical member 162 is connected to bracket 160, to a lower end 174. In this example arrangement, vertical member 162 has a plurality of holes 176 extending through vertical member 162 to facilitate attachment of sensor cable segment 70 by fastener 164.

### Fastener 164:

Fastener 164 is formed of any suitable size, shape, and design and is configured to connect support cable 78 of sensor cable segment 70 to vertical member 162. In some various different arrangements, fastener 164 may be any fastening means or method known in the art including but not limited to, for example: eyes, links, loops, sockets, threads, screws, bolts, buttons, clips, clamps, grips, saddles, ferrules, tucks, interconnects, friction fittings, clips, pins, clamps, other coupling devices, welds, adhesives, chemical bonding, or the like, or combinations thereof.

### Tie Downs 64:

In some applications, it is desirable to secure a lower end of modular sensor cable 60 in grain bin 12 in order to ensure that movement of grain when filling grain bin 12 does not move sensors 122 to different positions than intended. However, securing modular sensor cables 60 can be difficult for many grain bins 12 that utilize sweep systems to facilitate removal of grain. An exemplary sweep system is described in U.S. Patent Application Publication 2021/0051856, titled SWEEP SYSTEM FOR FULL ELEVATED FLOOR GRAIN BINS, and published Feb. 25, 2021, which is hereby incorporated by reference herein. As described therein, when a sweep system is operated, the sweep system is rotated around the floor of a grain bin 12, which helps moves grain to one or more points where grain is removed from the grain bin 12. In one or more arrangements, system 10 includes tie downs to connect a lower end of modular sensor cables 60 (approximately 36 inches above a floor of the grain bin) to the floor using fishing line or other suitable material that will break away when a sweep is operated and permit to rotate unincumbered.

Tie downs 64 are formed of any suitable size, shape, and design and are configured to connect to lower connection feature 114 of housing 74 and facilitate securing tie downs 64 to a floor of grain bin (e.g., using fishing line). In the arrangement shown, as one example, tie downs 64 each include a connector 180 and a tie feature 182.

### Connector 180:

Connector 180 is similar to upper connection feature 112 and may be formed of any suitable size, shape, and design and is configured to facilitate connection of tie down 64 with lower connection feature 114 housing 74 of the lowered sensor cable segment 70 of a modular sensor cable 60. In the arrangement shown, as one example, connector 180 is a threaded post. However, the embodiments are not so limited. Rather, it is contemplated that in some various different arrangements, connector 180 may be implemented using various different types of connectors including but not limited to, for example: eyes, links, loops, sockets, threads, screws, bolts, buttons, clips, clamps, grips, saddles, ferrules, tucks, interconnects, friction fittings, clips, pins, clamps, other coupling devices, welds, adhesives, chemical bonding, or the like or combinations thereof.

### Tie Feature 182:

Tie feature 182 is formed of any suitable size, shape, and design and is configured to facilitate securing tie downs 64 to a floor of grain bin (e.g., using fishing line). In the arrangement shown, tie feature has an eye shape through which fishing line may be threaded on tied on. However, the embodiments are not so limited. Rather, it is contemplated that in some various different arrangements, tie feature 182 may be implemented using various different types of features including but not limited to, eyes, heads, hooks, cleats, loops, straps, links, loops, sockets, threads, screws, bolts, buttons, clips, clamps, grips, saddles, ferrules, tucks, interconnects, friction fittings, clips, pins, clamps, other coupling devices, adhesives, chemical bonding, or the like or combinations thereof.

### Dummy Load 188:

In one or more arrangements, system includes a dummy load 188 (not shown) configured to connect to lower electrical connector 128 of sensor circuit 76 of the lowest sensor cable segment 70 of modular sensor cable 60. Dummy load 188 is formed of any suitable size, shape, and design and is configured to adjust impedance at lower electrical connector 128 of sensor circuit 76 to improve characteristics for transmission of data by sensor circuit 76 of the lowest sensor cable segment 70.

### Alternative Arrangement:

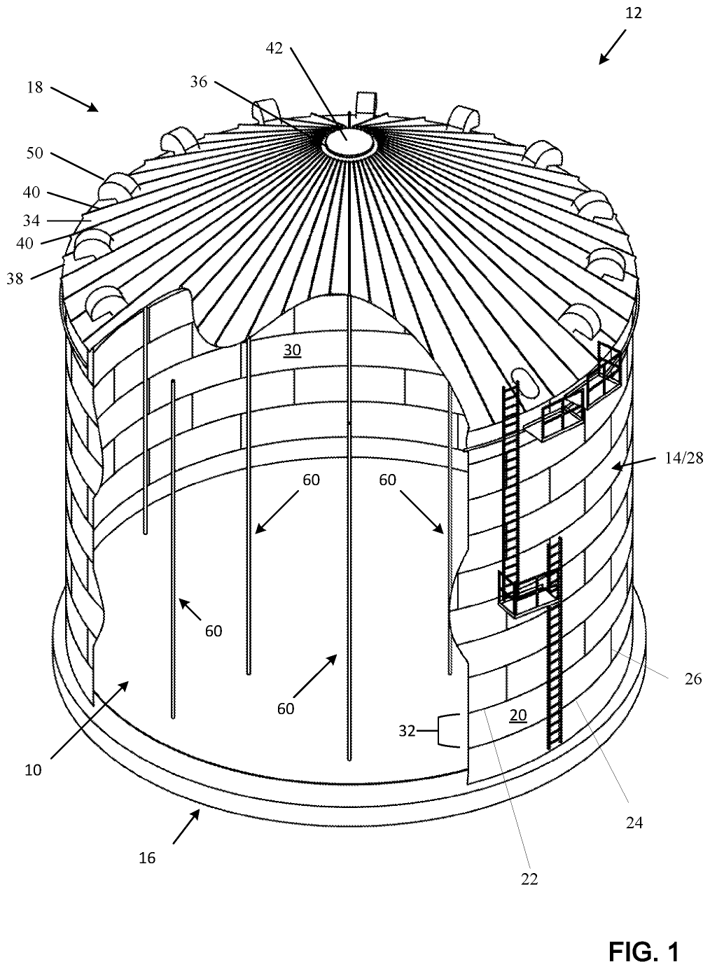

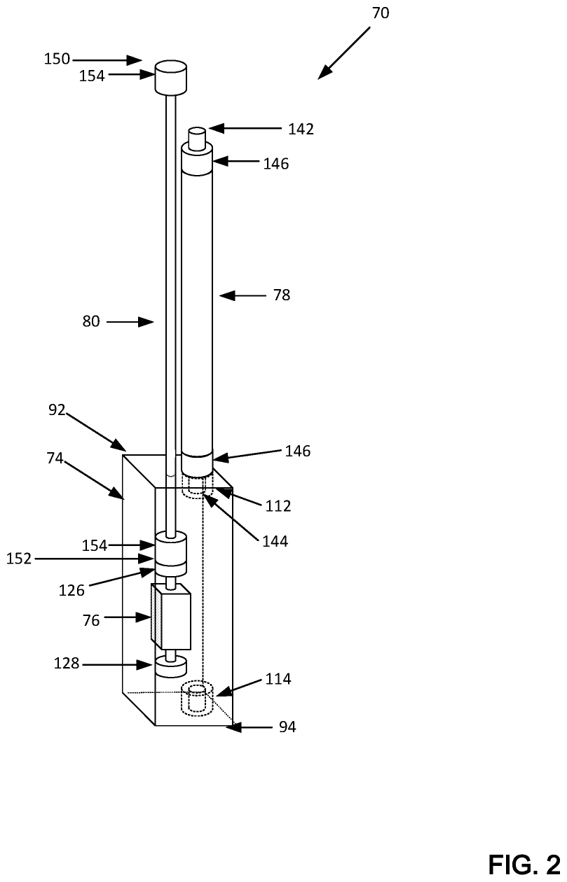

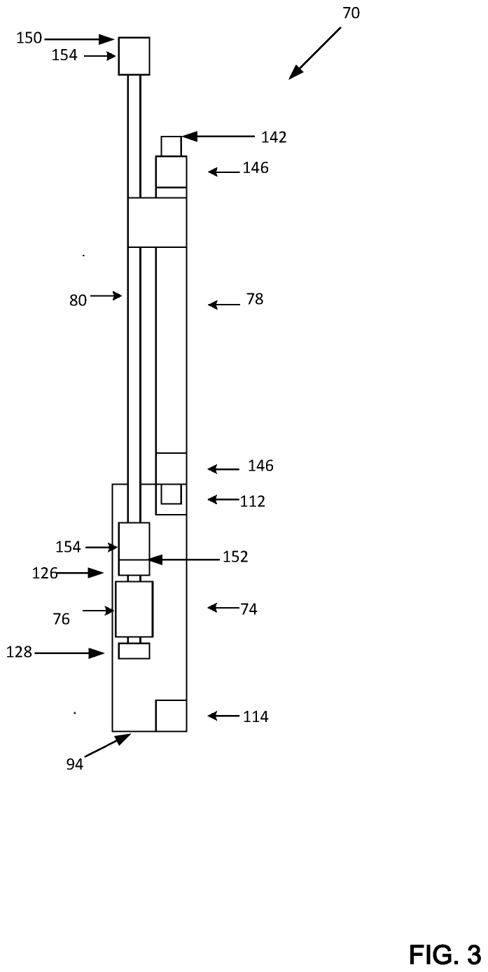

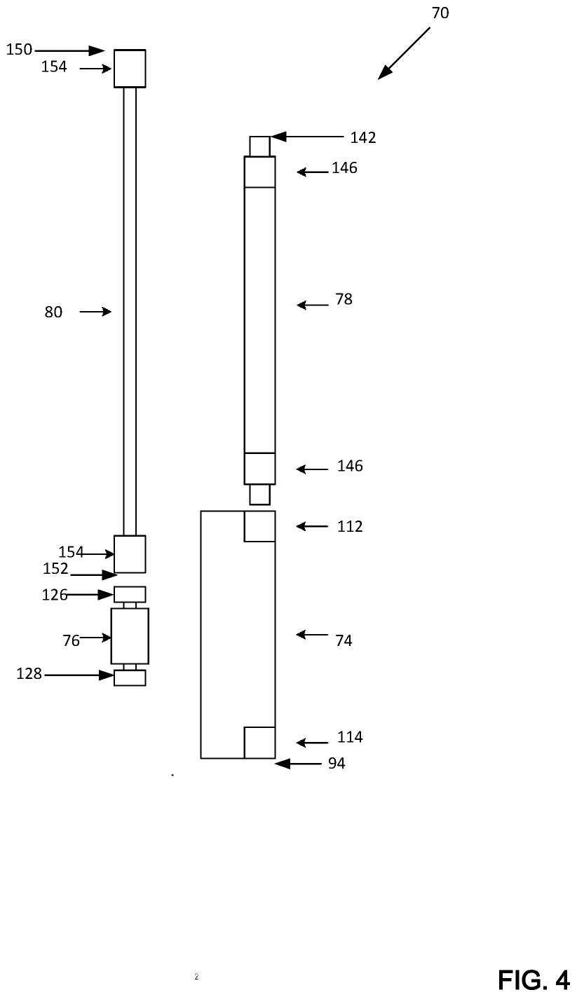

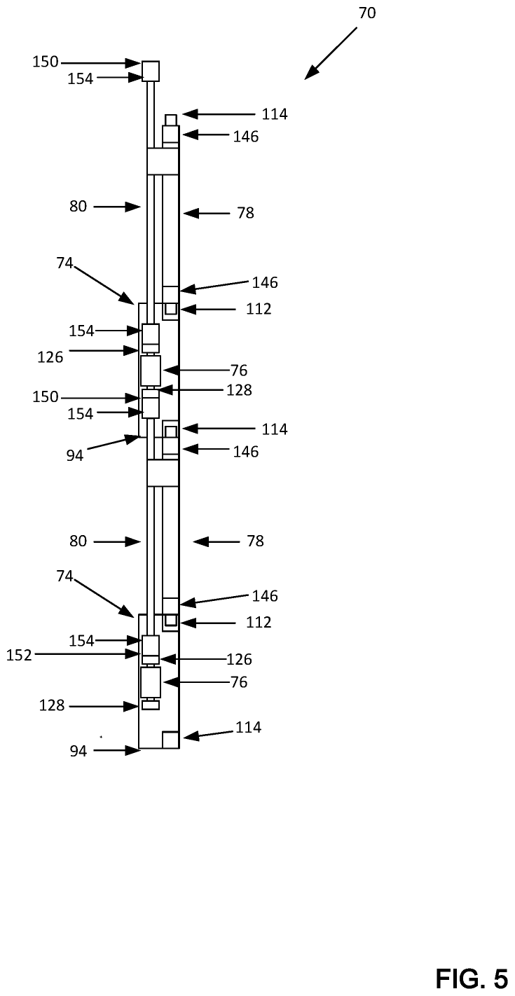

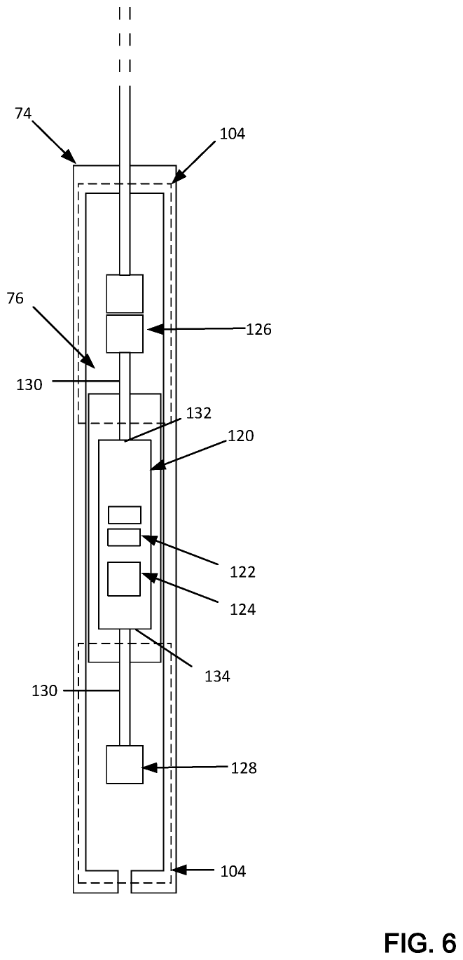

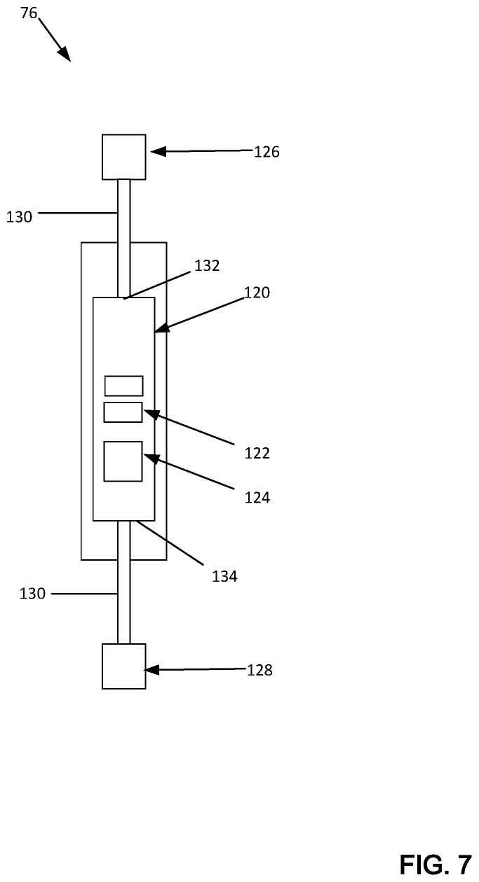

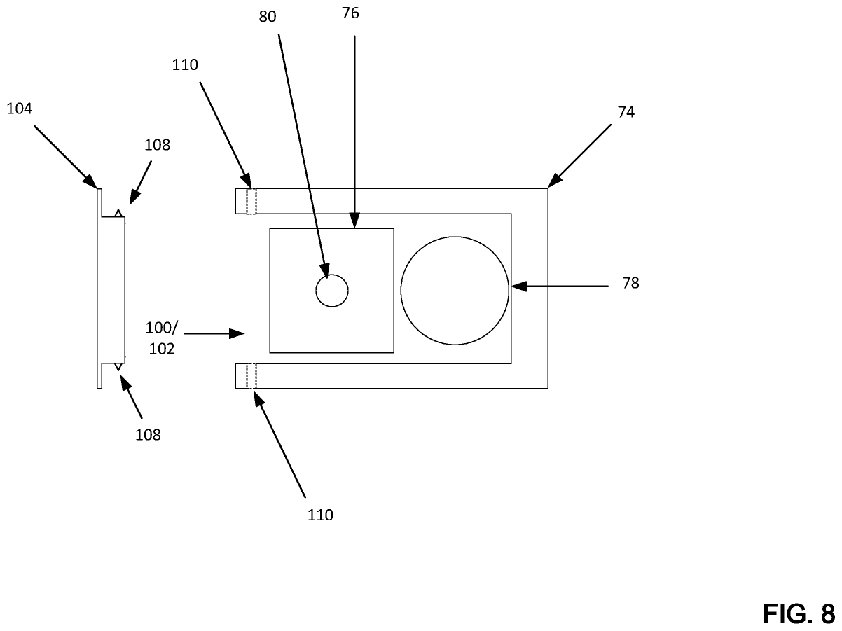

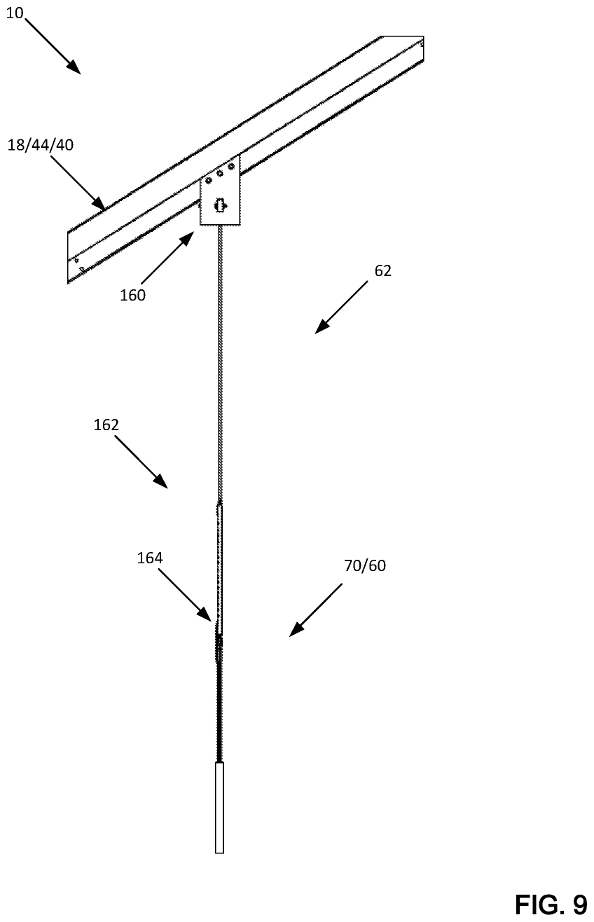

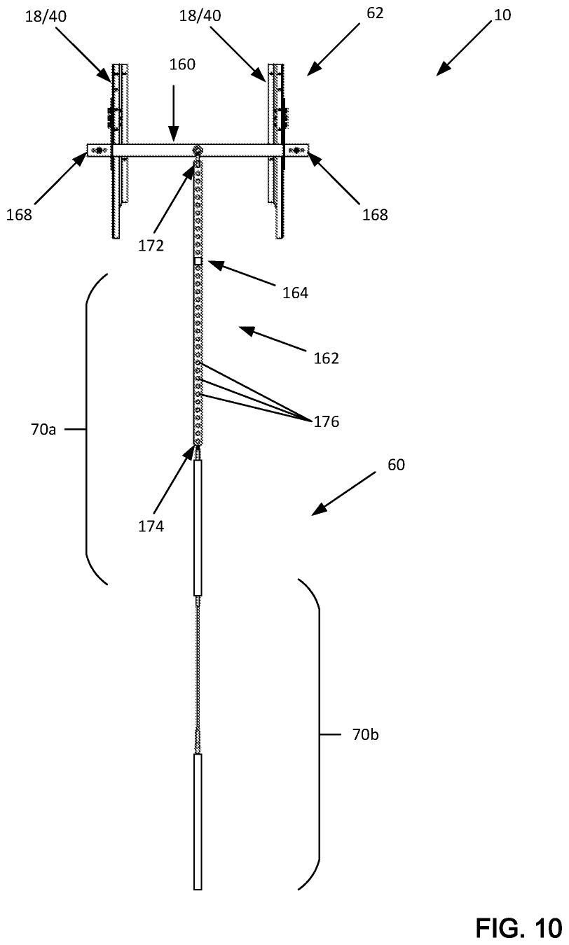

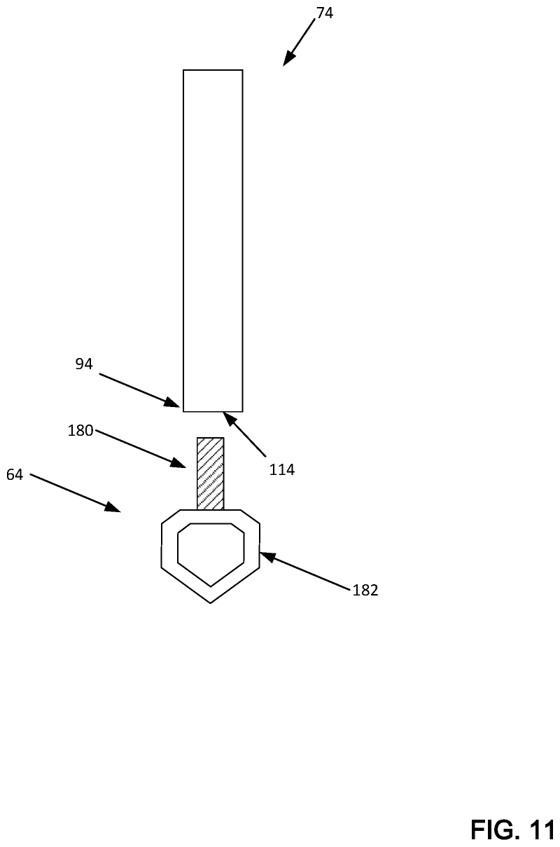

The arrangements shown in FIG. 1-14 are primarily shown and discussed as having weight of sensor cable segments 70 being transferred through and supported by the housing 74 in each sensor cable segment 70 of the modular sensor cable 60. However, the embodiments are not so limited. Rather, it is contemplated that in one or more arrangements, weight of sensor cable segments 70 may be transferred through and supported entirely by the support cable 78 in each sensor cable segment 70, which extends the length of the sensor cable segment 70.

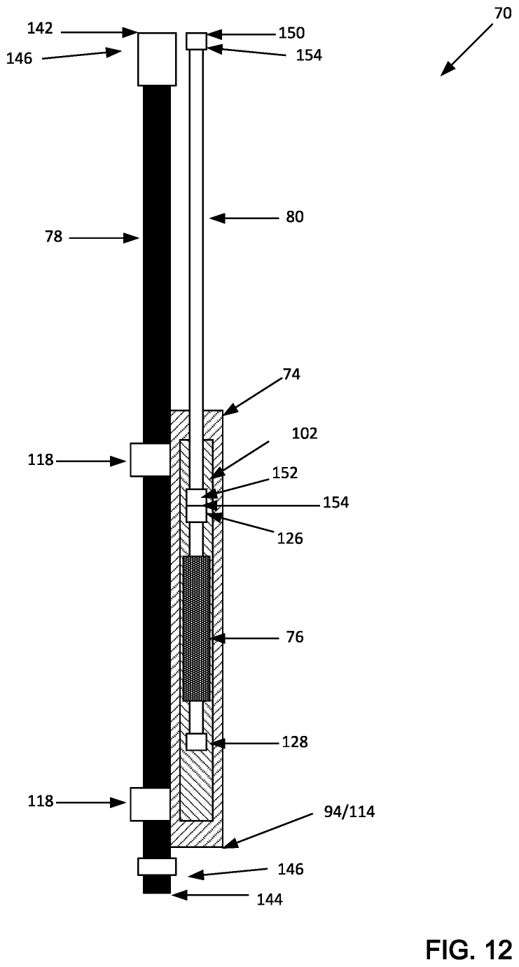

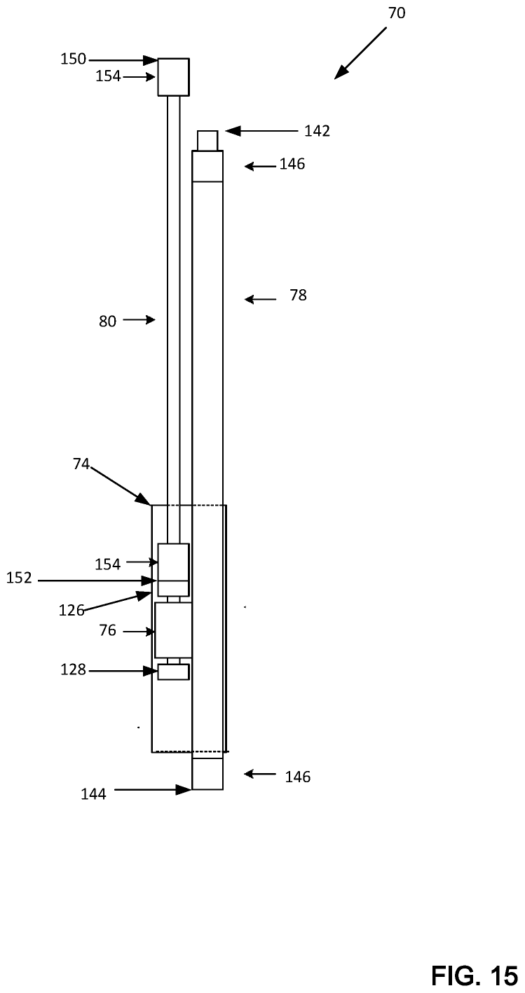

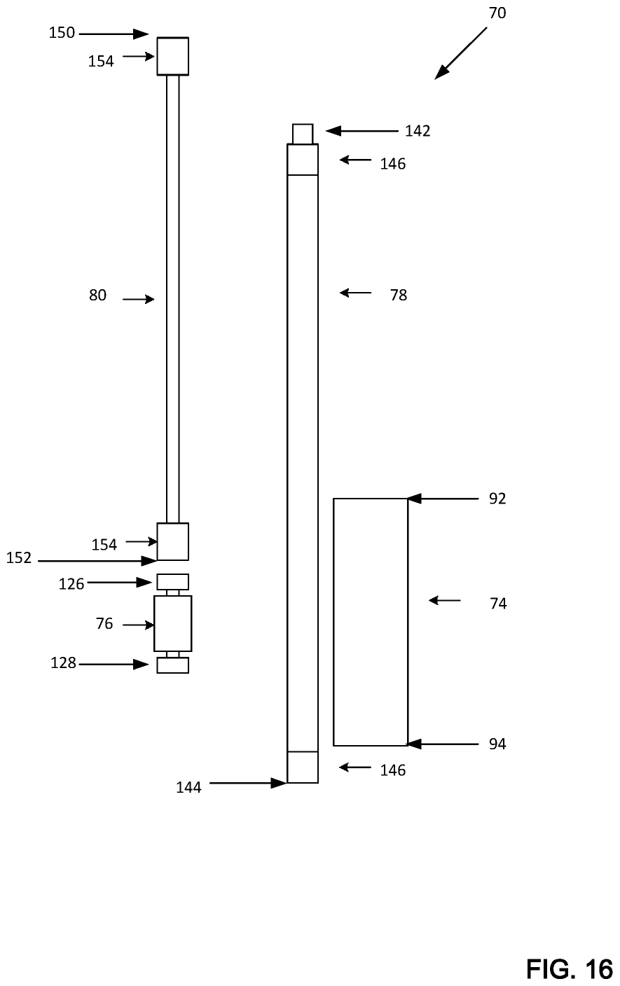

FIGS. 12-17 show example sensor cable segment 70 of such an alternative arrangement of system 10. The arrangements shown in FIGS. 12-17 are similar to the system 10 shown and discussed with reference to FIGS. 1-11 and as such the disclosure related to the arrangements shown in FIGS. 1-11 applies to the arrangements shown in FIG. FIGS. 12-17 unless stated specifically herein.

In the arrangement shown, as one example, support cable 78 extends the length of the sensor cable segment 70. In this example arrangement, termination connector 146 positioned at lower end 134 of support cable 78 is configured to connect with a termination connector 146 of upper end 142 of support cable 78 of another sensor cable segment 70 connected thereto.

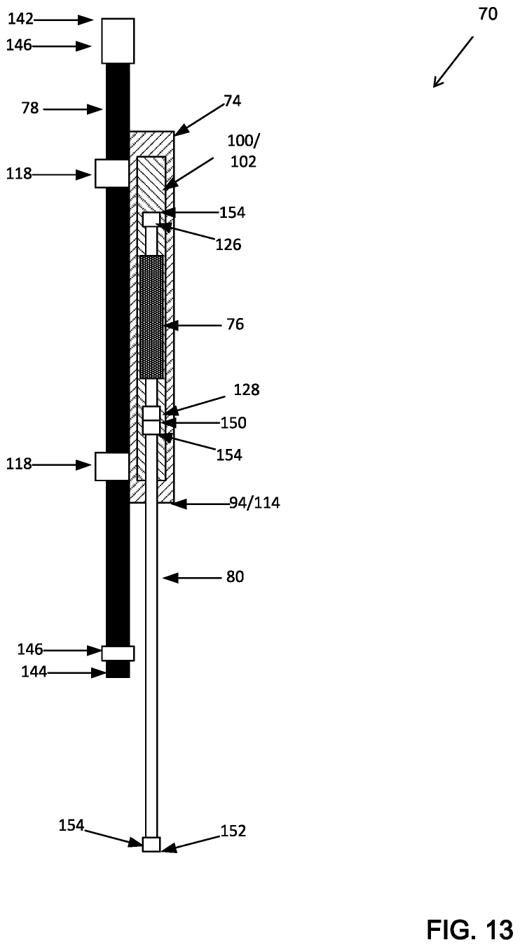

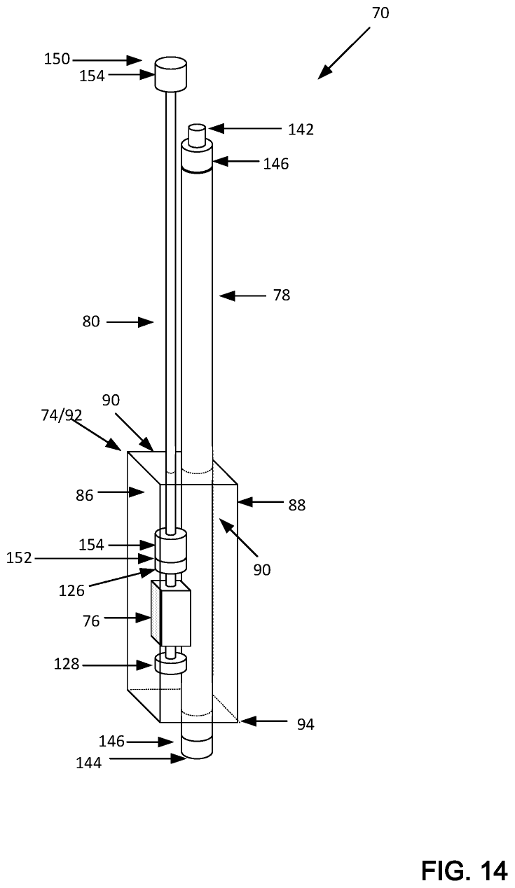

In the arrangement shown, as one example, upper connection feature 112 and lower connection feature 114 are omitted from housing 74. Rather, housing 74 is connected to support cable 78 by a set of cable connection features 118. In the example arrangements shown in FIGS. 12 and 13, cable connection features 118 connect support cable 78 to a side 90 of housing 74. As some other examples, in the arrangements shown in FIGS. 14-17, support cable 78 extends through housing 74. In one or more arrangements, housing 74 includes cable connection features 118 within housing 74 that are configured to crimp onto support cable 78 to facilitate connection of housing 74 with support cable 78.

However, the arrangements are not so limited. Rather, it is contemplated that in one or more arrangements, cable connection features 118 connect support cable 78 to the interior and/or exterior of the front 86, back 88, sides 90, or any other portion of housing 74. Moreover, it is contemplated that in various arrangements, housing 74 may be connected to support cable 78 using various methods and/or means including but not limited to, eyes, links, loops, sockets, threads, screws, bolts, buttons, clips, clamps, grips, saddles, ferrules, tucks, interconnects, friction fittings, clips, pins, clamps, other coupling devices, welds, adhesives, chemical bonding, or the like or combinations thereof. In the arrangement shown, cable connection features 118 are loop brackets that extend around support cable 78 to clamp support cable 78 to housing 74. However, the embodiments are not so limited. Rather, it is contemplated that in some various different arrangements, cable connection features 118 may be implemented using various different types of methods or means for connecting including but not limited to, for example: eyes, links, loops, sockets, threads, screws, bolts, buttons, clips, clamps, grips, saddles, ferrules, tucks, interconnects, friction fittings, clips, pins, clamps, other coupling devices, welds, adhesives, chemical bonding, or the like or combinations thereof.

Because weight is supported by support cable 78 instead of housing 74, housing may be made of a wider variety of materials such as plastics that are, for example, less strong, lighter, cheaper, and/or are easier to manufacture.

### Data System 66:

In one or more arrangements, system 10 includes a data system 66. Data system 66 is formed of any suitable any suitable size, shape, and design and is configured to receive the sensor data from modular sensor cables 60 in grain bin 12 to facilitate monitoring environmental conditions within grain bin 12 and/or performing automated tasks in response to the sensor data. In the arrangement shown, as one example, data system 66 includes a control circuit 202 and a user interface 204, among other components.

User interface 204:

User interface 204 is formed of any suitable size, shape, design, technology, and in any arrangement and is configured to facilitate user control and/or adjustment of various components of system 10. In one or more arrangements, as one example, user interface 204 includes a set of inputs (not shown). Inputs are formed of any suitable size, shape, and design and are configured to facilitate user input of data and/or control commands. In some various different arrangements, inputs may include various types of controls including but not limited to, for example, buttons, switches, dials, knobs, a keyboard, a mouse, a touch pad, a touchscreen, a joystick, a roller ball, or any other form of user input. Optionally, in one or more arrangements, user interface 204 includes a display (not shown). Display is formed of any suitable size, shape, design, technology, and in any arrangement and is configured to facilitate display information of settings, sensor readings, time elapsed, and/or other information pertaining to proper storage of contents of grain bin 12. In one or more arrangements, display may include, for example, LED lights, meters, gauges, screen or monitor of a computing device, tablet, and/or smartphone. Additionally or alternatively, in one or more arrangements, the inputs and/or display may be implemented on a separate device that is communicatively connected to control circuit 202. For example, in one or more arrangements, operation of control circuit 202 may customized using a smartphone or other computing device that is communicatively connected to the control circuit 202 (e.g., via Bluetooth, WIFI, and/or the internet). In one or more arrangements, user interface 204 may be a provided by a web-portal or software as a service (SaaS) application accessible over the internet.

In one or more arrangements, user interface 204 is configured to provide a dashboard for real time visualization sensor data and/or analytics derived data metrics to facilitate true understanding of conditions through grain bin 12 and how conditions change over time. Such monitoring is important because conditions within a grain bin 12 are rarely uniform. Crops are normally placed in grain bins 12 for storage at temperatures much warmer than winter temperatures. Since grains are good insulators, grain in center of bin 12 will be at same temperature as at harvest, even after outside temperatures have dropped well below freezing. The temperature difference may additionally cause migration of moisture within grain bin 12, which can lead to mold or spoilage.

The temperature difference may additionally cause migration of moisture within grain bin 12, which can lead to mold or spoilage. For example, air near bin wall cools and sinks to bottom of bin, pushing air up in the center of the grain bin 12. When grain near the sidewalls 14 cools the warm air, moisture in the air condenses. Cool air cannot hold as much moisture as warm air. As this circulation continues, moisture begins to accumulate near top center of bin. Crusting is an indication of moisture accumulation and mold growth. Conversely, in spring and summer months when outside air gets warmer, moisture migration can occur in the opposite way and moisture will accumulate at bottom of bin. By monitoring conditions throughout a grain bin 12, appropriate action can be taken to mitigate damages when a hotspot or other condition indicative of an adverse condition is detected.

### Control Circuit 202:

Control circuit 202 is formed of any suitable size, shape, design and is configured to coordinate receipt, routing, and/or storage of data from sensors 122 to facilitate monitoring environmental conditions within grain bin 12 and/or performing automated tasks in response to the sensor data. In the arrangement shown, as one example implementation, control circuit 202 includes a communication circuit 210, a processing circuit 212, and a memory 214 having software code 216 or instructions that facilitates the operation of system 10.

Processing circuit 212 may be any computing device that receives and processes information and outputs commands according to software code 216 stored in memory 214. For example, in some various arrangements, processing circuit 212 may be discreet logic circuits or programmable logic circuits configured for implementing these operations/activities, as shown in the figures and/or described in the specification. In certain arrangements, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of software code stored in and accessible from memory 214. Memory 214 may be any form of information storage such as flash memory, ram memory, dram memory, a hard drive, or any other form of memory.

Processing circuit 21 and memory 214 may be formed of a single combined unit. Alternatively, processing circuit 212 and memory 214 may be formed of separate but electrically connected components. Alternatively, processing circuit 212 and memory 214 may each be formed of multiple separate but communicatively connected components.

Software code 216 is any form of instructions or rules that direct processing circuit 212 how to receive, interpret and respond to information to operate as described herein. Software code 216 or instructions is stored in memory 214 and accessible to processing circuit 212. As an illustrative example, in one or more arrangements, software code 216 or instructions may configure processing circuit 212 control circuit 202 to retrieve and store data from sensors 122. Additionally or alternatively, in one or more arrangements, software code 216 or instructions may configure processing circuit 212 control circuit 202 to perform various preprogramed actions in response to signals from sensors 122 satisfying one or more trigger conditions.

As some illustrative examples, some actions that may be initiated by control circuit 202 in response to signals from sensors 122 and/or user input from user interface 204 include but are not limited to, for example, controlling augers and conveyors of loading and/or unloading systems, controlling grain dryers, controlling environmental control systems (e.g., temperature control systems, air circulation systems, fumigation systems, and/or preservative application systems), and/or sending notifications to users (e.g., n rails, SMS, push notifications, automated phone call, social media messaging, and/or any other type of messaging).

Communication circuit 210 is formed of any suitable size, shape, design, technology, and in any arrangement and is configured to facilitate communication with devices to be controlled, monitored, and/or alerted by data system 66. In one or more arrangements, as one example, communication circuit 210 includes a transmitter (for one-way communication) or transceiver (for two-way communication). In various arrangements, communication circuit 210 may be configured to communicate with various components of system 10 using various wired and/or wireless communication technologies and protocols over various networks and/or mediums including but not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA CDMA, LTE, FM/VHF/UHF networks, and/or any other communication protocol, technology or network.

### Example Operation:

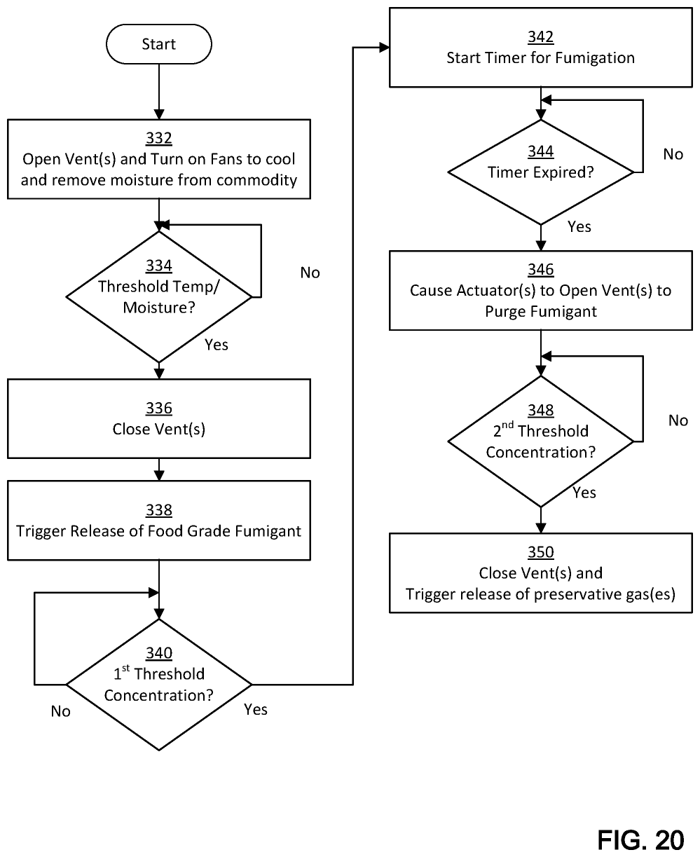

As an illustrative example, FIG. 20 shows a flow diagram of an example automated process that may be performed by a data system 66 in one or more arrangements. The process may be initiated by a user following loading of a commodity from a dryer in into grain bin 12. In this example, the data system 66 opens roof vents 50 and turns on an air circulation system at process block 332 to cool and remove moisture from the commodity. The process then holds at decision block 334 until a threshold temperature is reached. Once the threshold temperature is reached, the process proceeds to process block 336, where data system 66 closes roof vents 50. At process block 338, data system 66 causes a fumigation system to release a food grade fumigant into grain bin 12. At decision block 340, data system 66 monitors concentration of the fumigant in grain bin 12 using one or more sensors until a first threshold concentration is reached. Once the first threshold concentration is reached, data system 66 initiates a timer at process block 342, to ensure that fumigate is applied for a sufficient amount of time to be effective (e.g., as instructed by the manufacture). The process then holds at decision block 344 until the timer has expired. Once the timer has expired, the process proceeds to process block 346, where data system 66 causes actuators 282 to open roof vents 50 to purge the fumigant. At decision block 348, data system 66 monitors concentration of the fumigant in grain bin 12 using one or more sensors until a second threshold concentration that is safe for exposure is reached. In this example, once the second threshold concentration is reached, the process proceeds to process block 350, where data system 66 closes roof vents 50 and triggers release of a preservative (e.g. CO2) into grain bin 12 to prolong the shelf life of the commodity.

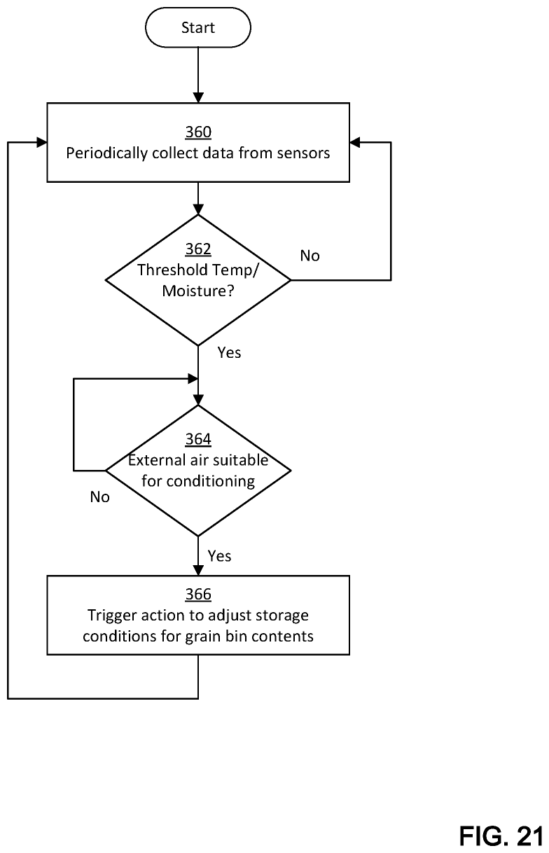

As another illustrative example, FIG. 21 shows a flow diagram of an example automated process that may be performed by a data system 66 to monitor long term storage in grain bin 12. At block 360, data system 66 periodically collects data from sensors of modular sensor cables 60 of system 10. While temperature or moisture readings do not exceed a predetermined threshold indicative of a problem at decision block 362, no action is taken and the process loops back to process block 360 until the next set of data is collected. If temperature or moisture readings exceed a predetermined threshold indicative of a problem at decision block 362, the process continues to decision block 364. In this example, the process halts at decision block 364 if external conditions are not suitable to condition the grain in the grain bin 12 to address the issue. For example, if high levels of moisture are detected that would call for aeration of grain in grain bin 12 to further dry the grain, the process may halt at decision block 364 if humidity/temperature of external air would not efficiently dry the grain when aerated. If and when external conditions are suitable, the process continues to block 366, where control circuit 202 of data system 66 triggers action of one or more systems to address the problematic condition detected at decision block 362. Such actions may include but are not limited to, for example, aeration of grain to remove moisture, cooling of grain, heating grain, spreading and/or redistribute grain within bin, and/or any other operation performed to facilitate storage of grain. After such operation is performed, the process returns to block 360 until the next set of data is collected.

The automated operations performed by data system 66 in these illustrative examples, avoid numerous manual tasks by the user. Moreover, in one or more arrangements, data system 66 may perform many operations at the same time, thereby reducing overall processing time.

From the above discussion it will be appreciated that the sensor system presented herein improves upon the state of the art. More specifically, and without limitation, it will be appreciated that in one or more arrangements, a sensor system is presented: that monitors environmental conditions throughout a grain storage device; that permits real-time monitoring of environmental conditions throughout a grain storage device; that has modular sensor cables that can be increased and decreased in length; that permits sensors to be replaced in the field without uninstalling sensor cables; that is durable; that is easy to manufacture; that is relatively inexpensive; that has a robust design; that is high quality; that is easy to install; that can be installed using conventional equipment and tools; that reduces grain bin corrosion; that reduces grain spoilage; and/or that can be used with any grain bin among other objects, features, or advantages.

It will be appreciated by those skilled in the art that other various modifications could be made to the device without parting from the spirit and scope of this disclosure. All such modifications and changes fall within the scope of the claims and are intended to be covered thereby.

What is claimed:

1. A modular sensor cable system for a grain bin, comprising:
a plurality of sensor cable segments;
wherein the plurality of sensor cable segments each include:
a housing;
a sensor circuit;
the sensor circuit positioned in the housing;
the sensor circuit having one or more sensors;
a support cable;
the support cable configured to operably connect the sensor cable segment to another one of the plurality of sensor cable segments;
a data cable;
the data cable configured to communicatively connect to the sensor circuit and to the sensor circuit of the other one of the plurality of sensor cable segments;
wherein the plurality of sensor cable segments are configured to operably connect together in series to form a multi-segment sensor cable;
wherein the multi-segment sensor cable extends from an upper end to a lower end.

2. The system of claim 1, wherein the support cables of the plurality of sensor cable segments are configured to operably connect together in series to support the multi-segment sensor cable.

3. The system of claim 1, wherein one end of the support cable of each of the plurality of sensor cable segments is configured to connect with the housing of the sensor cable segment and the other end of the support cable is configured to connect with the housing of another one of the sensor cable segments.

4. The system of claim 1, wherein the support cables of the plurality of sensor cable segments are configured to connect together in series.

5. The system of claim 1, wherein the support cable of each segment of the plurality of sensor cable segments extends through the housing of the segment.

6. The system of claim 1, wherein the support cable of each segment of the plurality of sensor cable segments is connected to an outer surface of the housing of the segment.

7. The system of claim 1, wherein the support cables of the plurality of sensor cable segments support the weight of the plurality of sensor cable segments and prevent transfer of vertical forces through the data cables of the plurality of sensor cable segments.

8. The system of claim 1, wherein the support cables of the plurality of sensor cable segments support the weight of the plurality of sensor cable segments and prevent transfer of vertical forces through the housings of the plurality of sensor cable segments.

9. The system of claim 1, wherein the support cables and housings of the plurality of sensor cable segments are connected together in series.

10. The system of claim 1, wherein the data cables and sensor circuits of the plurality of sensor cable segments are connected together in series.

11. The system of claim 1, wherein one of the plurality of sensor cable segments may be disconnected and replaced while the plurality of sensor cable segments remain connected together in series.

12. The system of claim 1, wherein the one or more sensors of the sensor circuit include a temperature sensor and a moisture sensor.

13. The system of claim 1, wherein the one or more sensors of the sensor circuit include a temperature sensor, a moisture sensor, and an optical sensor.

14. The system of claim 1, wherein the one or more sensors of the sensor circuit include a temperature sensor, a moisture sensor, an optical sensor, and a chemical sensor.

15. The system of claim 1, further comprising a hanger bracket assembly configured to operably connect a top-most sensor cable segment of the plurality of sensor cable segments in the multi-segment sensor cable to an elevated structure of the grain bin;
wherein the hanger bracket assembly is configured to connect with and suspend the top-most sensor cable segment at a plurality of different heights.

16. The system of claim 1, further comprising a tie down configured to operably connect to the lower end of the housing of a bottom-most sensor cable segment of the plurality of sensor cable segments in the multi-segment sensor cable;
wherein the tie down is configured to connect the lower end of the multi-segment sensor cable to an elevated structure of the grain bin with a floor of the grain bin using a line.

17. The system of claim 1, further comprising a data system configured to receive and store data generated by the one or more sensors of the sensor circuit of each sensor cable segment of the plurality of sensor cable segments.

18. The system of claim 1, further comprising a data system configured to:
receive and store data generated by the one or more sensors of the sensor circuit of each sensor cable segment of the multi-segment sensor cable; and
perform data analytics on the stored data to derive one or more data metrics.

19. The system of claim 1, further comprising a data system configured to:
receive and store data generated by the one or more sensors of the sensor circuit of each sensor cable segment of the multi-segment sensor cable; and
perform one or more operations to adjust environmental conditions within the grain bin in response to the stored data satisfying a predetermined set of conditions.

20. A modular sensor cable system for a grain bin, comprising:
a first sensor cable segment;
the first sensor cable segment having a first housing;
the first housing having an elongated shape extending from an upper end to a lower end;
the first sensor cable segment having a first sensor circuit;
the first sensor circuit positioned in the first housing;
the first sensor circuit having one or more sensors;
the first sensor circuit having an upper electrical connector and a lower electrical connector;
the first sensor cable segment having a first support cable;
the first support cable extending a length from an upper end to a lower end;
wherein the first housing is operably connected to the first support cable;
the first sensor cable segment having a first data cable extending from an upper end to a lower end;
the lower end of the first data cable communicatively connected to the upper electrical connector of the first sensor circuit;
wherein during operation, the first sensor circuit is configured to communicate a first set of data gathered from the one or more sensors of the first sensor circuit via the first data cable;
wherein when a second sensor cable segment is communicatively connected to the lower electrical connector of the first sensor circuit, wherein the first sensor circuit of the first sensor cable segment is configured to receive a second set of data from the second sensor cable segment and communicate the second set of data via the first data cable.

21. The system of claim 20, wherein the lower end of the support cable of the first sensor cable segment is operably connected to the upper end of the housing of the first sensor cable segment.

22. The system of claim 20, wherein the lower end of the support cable of the first sensor cable segment is operably connected to the upper end of the housing of the first sensor cable segment by threads.

23. The system of claim 20, further comprising the second sensor cable segment;
the second sensor cable segment including:
a second housing;
the second housing having an elongated shape extending from an upper end to a lower end;
a second sensor circuit;
the sensor circuit positioned in the second housing;
the second sensor circuit having one or more sensors;
the second sensor circuit having an upper electrical connector and a lower electrical connector;
the second sensor cable segment having a second support cable;
the second support cable extending from an upper end to a lower end;
wherein the upper end of the second support cable is operably connected to the first housing;
wherein the lower end of the second support cable is operably connected to the second housing;
a second data cable extending from an upper end to a lower end;
the lower end of the second data cable communicatively connected to the upper electrical connector of the second sensor circuit;
the upper end of the second data cable communicatively connected to the lower electrical connector of the first sensor circuit.

24. The system of claim 20, further comprising the second sensor cable segment;
the second sensor cable segment having a second sensor circuit;
the second sensor circuit having one or more sensors;
the second sensor cable segment having a second data cable;
wherein during operation, the second sensor circuit is configured to communicate the second set of data gathered from the one or more sensors of the second sensor circuit via the second data cable to the first sensor circuit;
wherein when a third sensor cable segment is communicatively connected to the second sensor circuit, wherein the second sensor circuit is configured to receive a third set of data from the second sensor cable segment and communicate the third set of data via the second data cable.

25. The system of claim 20, further comprising the second sensor cable segment;
wherein when the first sensor cable segment is suspended from an elevated structure of the grain bin and the second sensor cable segment is suspended from the first sensor cable segment, the first sensor circuit is removable from the first cable segment while maintaining suspension of the second sensor cable segment from the first sensor cable segment.

26. The system of claim 20, wherein the second sensor cable segment is detachable from the first sensor cable segment.

27. The system of claim 20, wherein the one or more sensors of the first sensor circuit include a temperature sensor and a moisture sensor.

28. The system of claim 20, wherein the first data cable does not carry weight of the first housing or second sensor cable segment.

29. The system of claim 20, wherein the second sensor cable segment includes a second support cable;
wherein the first housing has a connection feature positioned at the lower end of the first housing;
wherein the connection feature is configured to connect with and disconnect from the second support cable;
wherein the connection feature is configured to connect with and disconnect from a tie down;
wherein the tie down is configured to facilitate operable connection with a floor of the grain bin using a line.

30. A method, comprising:
installing a plurality of multi-segment sensor cables in a grain bin having a plurality of sidewall rings;
each of the plurality of multi-segments sensor cables having multiple sensor cable segments operably connected together in series;
each of the sensor cable segments having a sensor circuit;
the sensor circuit having one or more sensors;
expanding capacity of the grain bin by adding one or more sidewall rings to the plurality of sidewall rings;
increasing length of the plurality of multi-segment sensor cables by adding one or more sensor cable segments to each of the plurality of multi-segment sensor cables.

31. The method of claim 30, wherein installing the plurality of multi-segment sensor cables includes adjusting height at which the plurality of multi-segment sensor cables are positioned.

32. The method of claim 30, wherein the sensor cable segments each include:
a housing;
the housing having an elongated shape extending from an upper end to a lower end;
a sensor circuit;
the sensor circuit positioned in the housing;
the sensor circuit having one or more sensors;
the sensor circuit having an upper electrical connector and a lower electrical connector;
a support cable;
the support cable extending from an upper end to a lower end;
the lower end of the support cable configured to operably connect to the upper end of the housing;
the upper end of the support cable configured to operably connect to the lower end of the housing of a higher one of the plurality of sensor cable segments in the multi-segment sensor cable;
a data cable extending from an upper end to a lower end;
the lower end of the data cable configured to communicatively connect to the upper electrical connector of the sensor circuit;
the upper end of the data cable configured to communicatively connect to the lower electrical connector of the sensor circuit of the higher one or the plurality of sensor cable segments;
wherein during operation, the sensor circuit is configured to communicate a first set of data gathered from the one or more sensors of the sensor circuit via the data cable;
wherein when a lower one of the plurality sensor cable segments in the multi-segment sensor cable is communicatively connected to the lower electrical connector of the sensor circuit, wherein the sensor circuit is configured to receive a second set of data from the lower sensor cable segment and communicate the second set of data via the data cable.
